(19) United States
(12) Patent Application Publication
(10) Pub. No.: US 2012/0092730 A1
(43) Pub. Date: Apr. 19, 2012

(54) INFORMATION PROCESSING APPARATUS, INFORMATION PROCESSING METHOD, AND STORAGE MEDIUM STORING A PROGRAM THEREOF

(75) Inventor: Nobushige Aoki, Tokyo (JP)

(73) Assignee: CANON KABUSHIKI KAISHA, Tokyo (JP)

(21) Appl. No.: 13/251,428

(22) Filed: Oct. 3, 2011

(30) Foreign Application Priority Data
Oct. 15, 2010 (JP) 2010-232782

(51) Int. Cl. G06F 17/00; G06K 15/02

(52) U.S. Cl. 358/1.18; 715/234

(57) ABSTRACT

An information processing apparatus acquires a first structured document containing a plurality of elements and having designated a second structured document to be inserted into a frame within a web page that is based on the first structured document, acquires the second structured document designated in the first structured document acquired by the first acquiring unit, and selects an element to be output, from the elements contained in the first structured document and the second structured document, based on the plurality of elements contained in the first structured document and an element contained in the second structured document.

### BACKGROUND OF THE INVENTION

1. Field of the Invention

The present invention relates to an information processing apparatus for processing document data having a hierarchical structure, a display control method in the information processing apparatus, and a storage medium storing a program thereof.

2. Description of the Related Art

Acquiring various information by accessing web pages on the Internet is now common. A web page is a structured document written in a structured language such as HTML (HyperText Markup Language) or XHTML (Extensible HyperText Markup Language). Web pages are displayed on a display by software called a browser.

Also, using FRAME elements or IFRAME (Inline FRAME) elements in a web page enables other structured documents to be embedded in the web page and displayed in the browser. That is, within a web page based on a structured document, a frame is designated separately to the frame of the web page, and a web page based on a different structured document is inserted into that frame. Further, an overflow attribute and an overflow style can be set for each element within a web page. This results in a scroll bar being displayed for the frame within the web page, and enables another structured document to be embedded in the web page and displayed such that only a partial area of a web page is displayed within the frame designated by the IFRAME element.

On the other hand, in the case of printing a web page with a printing apparatus, depending on the user, he or she may want to print a partial area of the web page rather than the entire web page. In view of this, Japanese Patent No. 3588337 describes a technique for designating an area to be printed within a web page in accordance with an instruction by the user, and extracting and printing the designated area as an image. For example, an area within a web page displayed in the browser can be selected using a pointing device or the like, and the selected area can be extracted and printed as an image.

Consider the case where web page data is embedded as a frame within the web page as with the above IFRAME is displayed, and the user designates an area to be output in the web page, as with the technique described in the above Japanese Patent No. 3588337. In this case, in order to designate data embedded in the web page as an output target, the user must designate the area in which the data is displayed by performing a separate operation to the operation for designating the area to be output in the web page. For example, there may be a case in which all of the data embedded in the web page cannot be displayed in the web page. In this case, the user needs to designate the area to be output by separately scrolling through the frame of the embedded data, independently of scrolling through the web page.

### SUMMARY OF THE INVENTION

An aspect of the present invention is to eliminate the above-mentioned problems with the conventional technology. The present invention provides an information processing apparatus with which an area to be output can be designated with a simple operation, in a web page in which data is embedded in a frame within the web page, an information processing method, and a storage medium storing a program thereof.

The present invention in its first aspect provides an information processing apparatus an information processing apparatus comprising: a first acquiring unit configured to acquire a first structured document, the first structured document containing a plurality of elements and having designated a second structured document to be inserted into a frame within a web page that is based on the first structured document; a second acquiring unit configured to acquire the second structured document designated in the first structured document acquired by the first acquiring unit; and a selecting unit configured to select an element to be output, from elements contained in the first structured document and the second structured document, based on the plurality of elements contained in the first structured document acquired by the first acquiring unit and an element contained in the second structured document acquired by the second acquiring unit.

The present invention in its second aspect provides an information processing method comprising: a first acquiring step of acquiring a first structured document, the first structured document containing a plurality of elements and having designated a second structured document to be inserted into a frame within a web page that is based on the first structured document; a second acquiring step of acquiring the second structured document designated in the first structured document acquired in the first acquiring step; and a selecting step of selecting an element to be output, from the elements contained in the first structured document and the second structured document, based on the plurality of elements contained in the first structured document acquired in the first acquiring step and an element contained in the second structured document acquired in the second acquiring step.

The present invention in its third aspect provides a computer-readable storage medium storing a program for causing a computer to execute: acquiring a first structured document, the first structured document containing a plurality of elements and having designated a second structured document to be inserted into a frame within a web page that is based on the first structured document; acquiring the second structured document designated in the acquired first structured document; and selecting an element to be output, from the elements contained in the acquired first structured document and the acquired second structured document, based on the plurality of elements contained in the acquired first structured document and an element contained in the acquired second structured document.

According to the present invention, a user is able to designate an area to be output, in a web page in which data is embedded as a frame within the web page, with a simple operation.

Further features of the present invention will become apparent from the following description of exemplary embodiments with reference to the attached drawings.

### BRIEF DESCRIPTION OF THE DRAWINGS

FIG. 1 is a block diagram showing the configuration of a system including an information processing apparatus.

FIG. 2 is a block diagram showing the internal configuration of a PC.

FIG. 3 is a block diagram showing the configuration of software implemented on the PC.

FIG. 4 is a diagram showing an example of a GUI screen displayed on a display apparatus.

FIG. 5 is a diagram showing another example of a GUI screen displayed on a display apparatus.

FIG. 6 is a diagram showing an example of a structured document.

FIG. 7 is a diagram showing an example of a DOM tree.

FIG. 8A and 8B are flowcharts showing a processing procedure up to extraction of a central element.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals are given to constituent elements that are the same, and description thereof will be omitted.

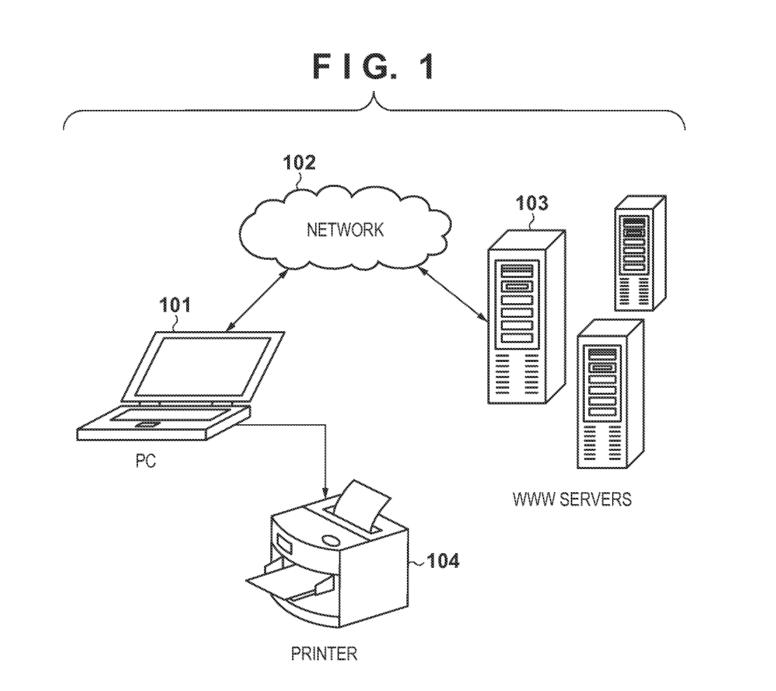

FIG. 1 is a block diagram showing the configuration of a system including an information processing apparatus in an embodiment according to the present invention. A PC 101 serving as the information processing apparatus is able to download web pages from a plurality of WWW servers 103 to the PC 101 via a network 102 and display the downloaded web pages. Here, a web page is a structured document written in a structured language such as HTML or XHTML. The PC 101 is also connected to a printer 104, and is able to download web pages on the WWW servers 103 to the PC 101 and print out the web pages on the printer 104.

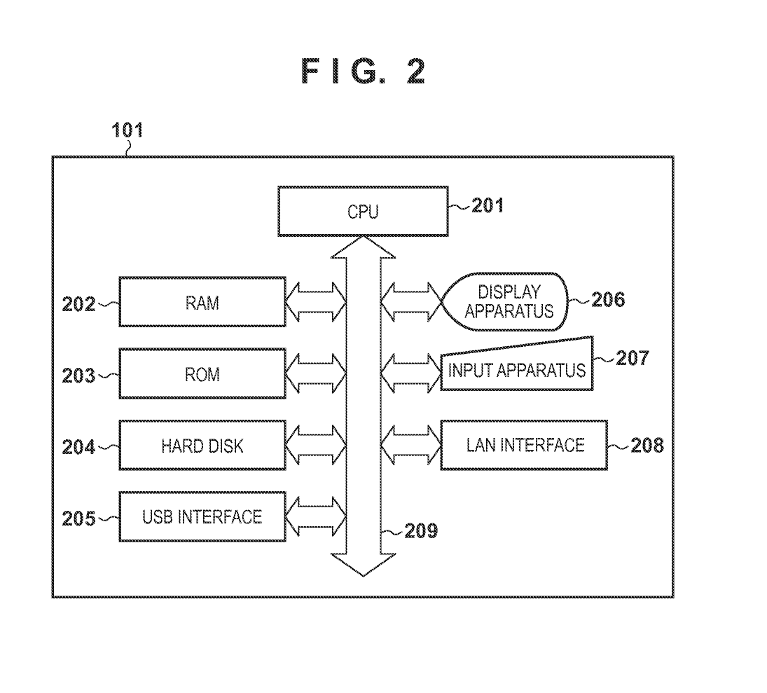

FIG. 2 is a block diagram showing the internal configuration of the PC 101. A CPU 201 processes data and commands in accordance with programs stored on a RAM 202, a ROM 203 or a hard disk 204. The RAM 202 is used as a temporary storage area during various processing by the CPU 201. The hard disk 204 stores an operating system (OS) and a web browser (hereinafter, referred to as a browser), as well as other application software and the like. A USB interface 205 is an interface for having a USB cable connected thereto and performing data communication with the printer 104. Note that communication with the printer 104 may be performed by SCSI, wireless or the like, rather than a USB cable.

A display apparatus 206 consists of a CRT or liquid crystal display and a graphics controller, and displays web pages downloaded from the WWW servers 103, print preview images, GUIs and the like. An input apparatus 207 is for the user to give various instructions to the PC 101, and is, for example, a pointing device or a keyboard. A system bus 209 connects the CPU 201, the RAM 202, the ROM 203, the hard disk 204 and the like, and data to be processed in the constituent elements is communicated over the system bus 209. A LAN interface 208 is an interface for having a LAN cable connected thereto. Data communication by the LAN cable can be performed with the external WWW servers 103 via a router (not shown) and the network 102, using the LAN interface 208. A configuration may also be adopted in which wireless data communication is performed by configuring the PC 101 with a wireless interface. Also, the PC 101 shown in FIG. 2 is a so-called laptop PC 101 in which the display apparatus 206 and the input apparatus 207 are integrated with a control unit that includes the CPU 201, the RAM 202 and the like. However, in the present embodiment, the PC 101 may be a so-called desktop apparatus in which the display apparatus 206 and the input apparatus 207 are separate.

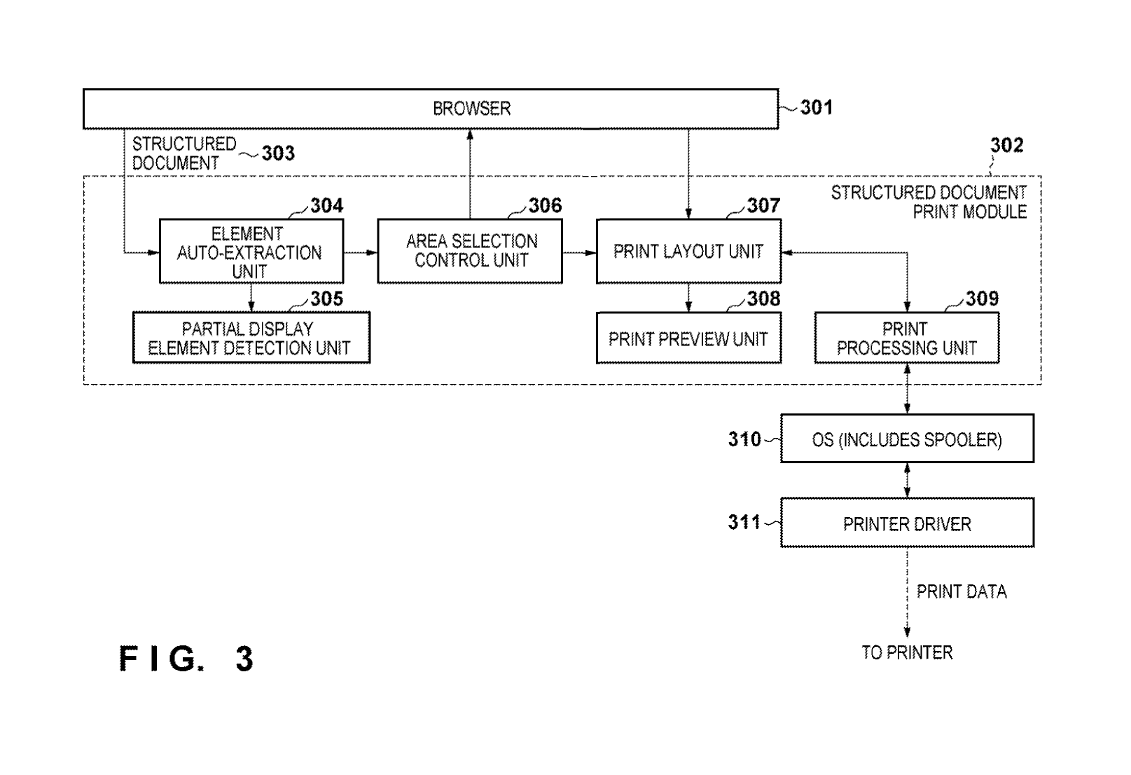

FIG. 3 is a block diagram showing the configuration of software executed by the PC 101, with programs corresponding to the functional blocks shown in FIG. 3 being stored on the ROM 203, for example. A browser 301 is an application for displaying web pages, and functions to download structured documents from the WWW servers 103 to the hard disk 204 of the PC 101, and display web pages on the display apparatus 206. A structured document such as the above is written using HTML, XHTML or the like, and elements such as text and images constituting the structured document are described using tags. A separate file called a CSS (Cascading Style Sheet) designating the display style of these elements is designated within the structured document. The browser 301 analyzes a structured document downloaded to the hard disk 204 and displays a web page on the display apparatus 206.

A structured document print module 302 is plug-in software that is called by the browser 301, and acquires a structured document 303 when called by the browser 301. The structured document print module 302 is executed in the case where the user gives an instruction for performing automatic extraction to the browser 301. Here, automatic extraction refers to processing for extracting an element that will serve as an output candidate (hereinafter, referred to as a central element) from among elements contained in a web page displayed on the display apparatus 206. The user is able to designate an area corresponding to the extracted element in the web page as an area to be targeted for output such as printing.

An element auto-extraction unit 304 analyzes the elements contained in the structured document 303 to create hierarchical structure data of the elements called a DOM (Document Object Model) tree, and stores the data in a temporary storage area such as the RAM 202. Further, the element auto-extraction unit 304 specifies and extracts a central element from the DOM tree, with reference to the area, text amount, text ratio, tag type and tag attributes of each element. Here, text amount refers to the number of characters within an element that are actually displayed in the browser 301, and text ratio refers to the ratio of text amount to total tag size of that element. The DOM tree and the processing of the element auto-extraction unit 304 will be discussed in detail later.

A partial display element detection unit 305 analyzes the structured document 303 and determines whether any FRAME elements, IFRAME elements or elements having an overflow attribute attached thereto (hereinafter, referred to as partial display elements) are contained in the structured document 303.

An area selection control unit 306 displays an area selection rectangle for indicating the output target, on an area within the web page corresponding to the central element extracted by the element auto-extraction unit 304. Also, the area selection control unit 306 provides the user with a function for changing the area selection rectangle manually by using an input apparatus 207 such as a pointing device or a keyboard. Further, the area selection control unit 306, on receipt of a print instruction from the user, acquires the coordinates of the area selection rectangle in the web page, and extracts the portion included in the rectangular area thereof in the web page as an intermediate data file.

Note that an intermediate data file is a file that holds character information and graphics information as vector data rather than bitmap data, and is created in printing a web page, for example. In particular, in order to enable a given area within a web page to be selected and extracted, that is, in order to enable part of an element in a structured document to be extracted, the intermediate data file is desired to be capable of extracting part of the vector data. A PDF (Portable Document Format) file, an EMF (Enhanced Metafile Format) file, an XPS (XML Paper Specification) file or the like, for example, can be used as such an intermediate data file.

Also, in the present embodiment, extracted characters and graphics are extracted as vector data rather than bitmap data, since the area within the web page is extracted as an intermediate data file as described above. Accordingly, in the case where magnification processing that involves enlarging or reducing extracted data is performed after the data has been extracted from within the web page, magnification of characters and graphics is performed on vector data. That is, degradation of the image following magnification can be suppressed, in comparison to the case where magnification is performed on data that is already bit-mapped, since magnification processing is performed in response to a command to render characters or graphics.

A print layout unit 307 determines the layout by corresponding the intermediate data file extracted by the area selection control unit 306 to the paper on which printing will be performed, in accordance with the print settings. Here, print settings include information such as paper size, resolution, and the printable area of the paper, and are acquired from a printer driver 311 via an OS 310. A print preview unit 308 displays the element laid out by the print layout unit 307 on the display apparatus 206 as a print preview. A print processing unit 309, on receipt of an instruction for starting printing from the user, executes rendering in accordance with placement information indicating the layout of the element by the print layout unit 307. The OS 310 provides an API (Application Programming Interface) for performing transmission/reception of print settings data with the structured document print module 302 and for the print processing unit 309 to perform rendering using the printer driver 311. Also, the OS 310 includes a spooler system for managing print jobs and various control software such as a port monitor for outputting printer commands to a port, although a detailed description thereof is omitted. The printer driver 311 generates print data in accordance with the rendering executed by the print processing unit 309, converts the print data to a printer command, and transmits the printer command to the printer 104. The printer 104 prints an image on paper based on the received printer command and document data.

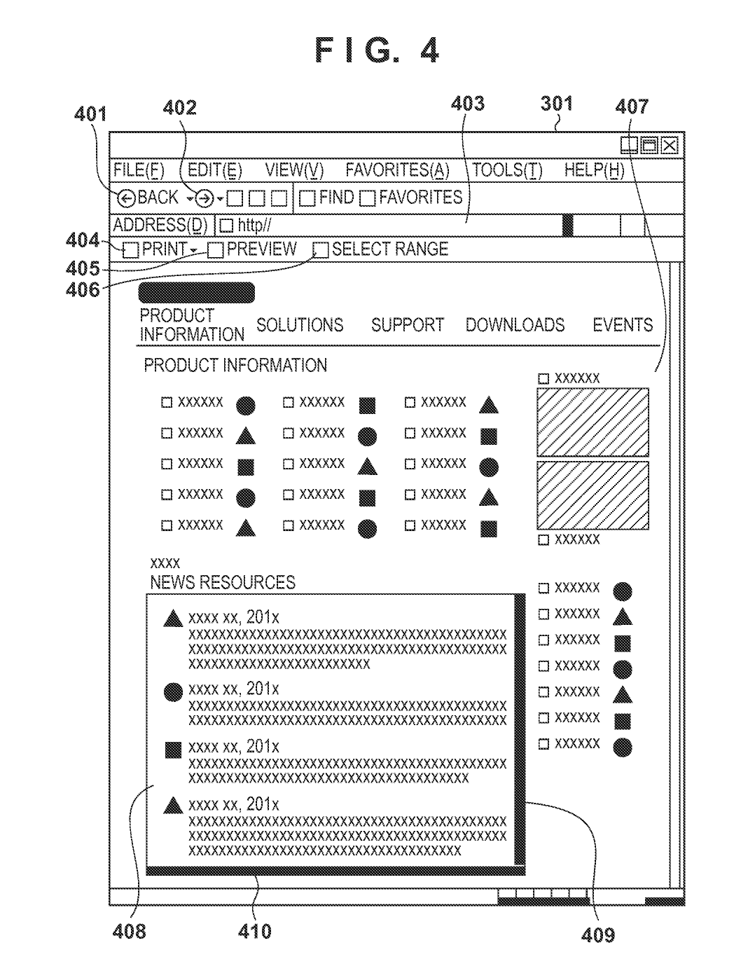

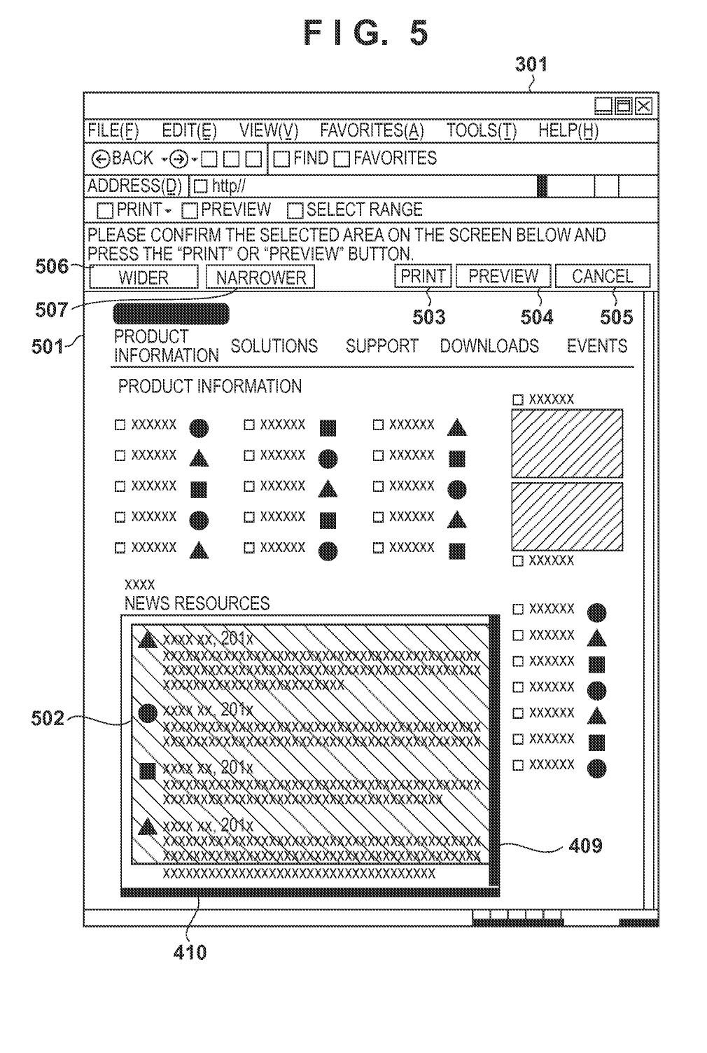

FIG. 4 and FIG. 5 are diagrams showing exemplary GUI screens displayed on the display apparatus 206 in the present embodiment. As shown in FIG. 4, the browser 301 displays a web page on a GUI. In the browser 301 a Back button 401, a Forward button 402 and an address input area 403 for switching the displayed web page are placed. Furthermore, a Print button 404, a Print Preview button 405, and an Auto Extract button 406 for instructing automatic extraction are also placed in the browser 301. When the user gives an instruction for performing automatic extraction of an element by pressing the Auto Extract button 406, the browser 301 calls the structured document print module 302.

As shown in FIG. 4, a first structured document 407 is displayed in the browser 301. Also, a second structured document 408 is a structured document designated by an IFRAME element whose display is partially restricted, and is embedded in a frame within the first structured document 407. A vertical scroll bar 409 and a horizontal scroll bar 410 are displayed for the frame in which the second structured document 408 is embedded, and the user is able to view the entire contents of the second structured document 408 by operating the scroll bars with an input apparatus 207 such as a pointing device.

FIG. 5 is a diagram showing a GUI screen that is displayed in the browser 301 after the user presses the Auto Extract button 406. As mentioned above, the Auto Extract button 406 is a button for giving an instruction to extract a central element serving as an output candidate within the displayed web page. When the user presses the Auto Extract button 406, the browser 301 calls the structured document print module 302, and the structured document print module 302 acquires the structured document corresponding to the web page being displayed by the browser 301. The structured document print module 302 extracts a central element from the file of the acquired structured document, and displays an area selection rectangle 502 on the area of the web page corresponding to the central element, as shown in FIG. 5. FIG. 5 shows the case where an area of the second structured document 408 designated as an IFRAME element is automatically selected as the central element.

As shown in FIG. 5, the area selection rectangle 502 is displayed as a translucent rectangle, and a “Wider” button 506 and a “Narrower” button 507 for displaying other elements in the group of central elements that includes the central element are further displayed. The group of central elements and the buttons 506 and 507 will be discussed later. The user is able to arbitrarily change the size of the area selection rectangle 502 relative to the central element, by performing a drag operation using an input apparatus 207 such as a pointing device. Further, a Print button 503 for starting printing with the area selection rectangle 502 relative to the central element targeted for printing is displayed, as shown in FIG. 5. When the Print button 503 is pressed, the area selection control unit 306 acquires the coordinates of the area selection rectangle 502 in the web page, and extracts the portion contained within the rectangular area thereof in the web page as an intermediate data file. Thereafter, the print layout unit 307 lays out the intermediate data file, and the print processing unit 309 executes print processing.

Also, a Preview button 504 for displaying a print preview of the area shown by the area selection rectangle 502 is displayed on the GUI screen as shown in FIG. 5. When the Preview button 504 is pressed, the area selection control unit 306 acquires the coordinates of the area selection rectangle 502 in the web page, and extracts the portion included within the rectangular area thereof in the web page as an intermediate data file. Thereafter, the print layout unit 307 lays out the intermediate data file, and when the print preview unit 308 displays a print preview on the display apparatus, an image of the area shown by the area selection rectangle 502 within the web page is displayed as the print target. As shown in FIG. 5, a Cancel button 505 for cancelling automatic extraction is also displayed, and when the cancel button 505 is pressed, display returns to the state of FIG. 4.

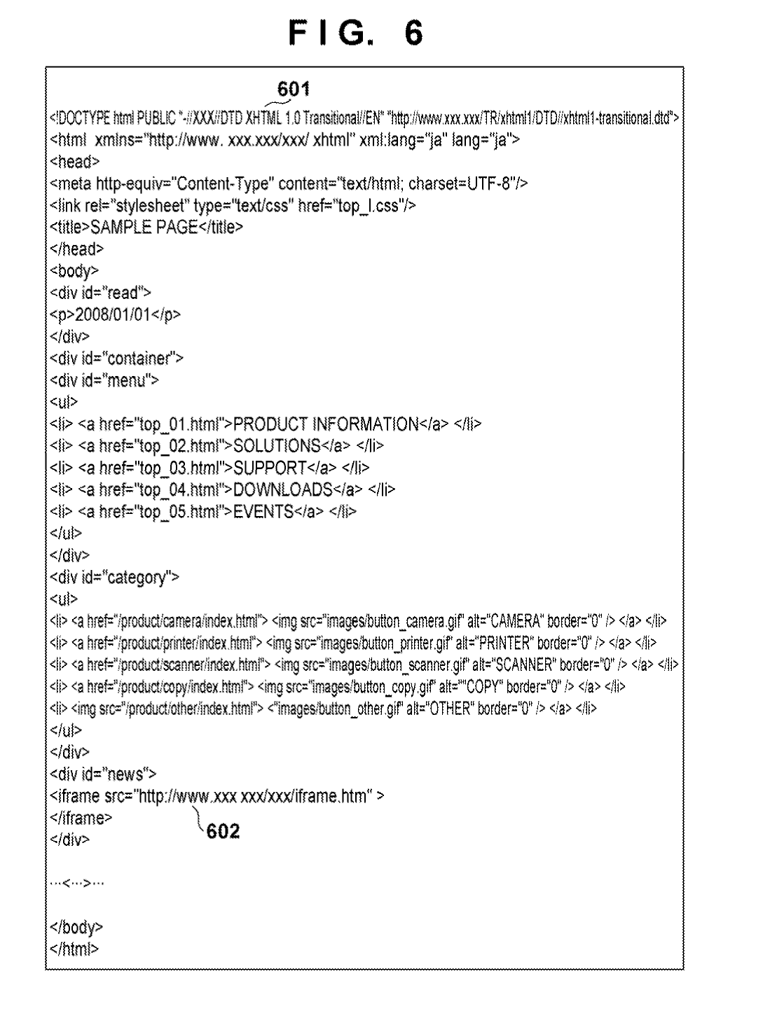

FIG. 6 shows an example of a structured document in the present embodiment. A structured document 601 shown in FIG. 6 corresponds to the first structured document 407 shown in FIG. 4. As shown in FIG. 6, the structured document 601 is written in XHTML format. Although not shown, with the structured document 601, layout information of the elements is described as a separate file using a CSS. Also, in the structured document 601, a second structured document is designated using an src attribute of an <iframe> tag 602. Although not shown, the second structured document is described in a separate file to the structured document 601.

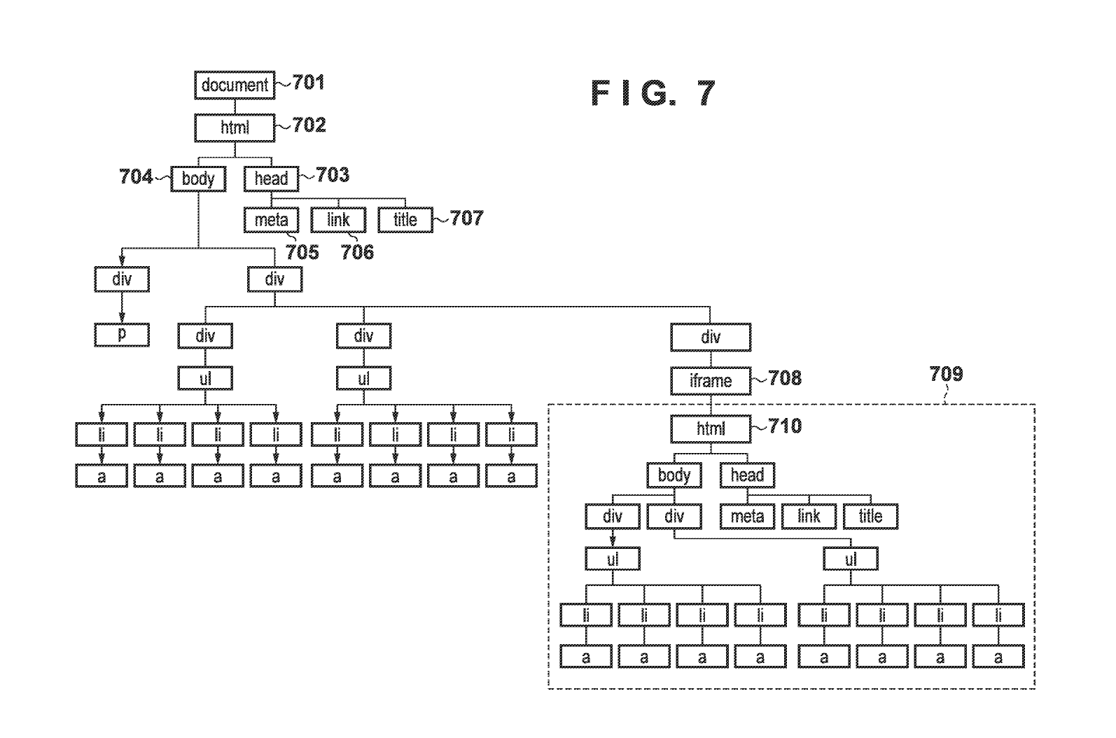

FIG. 7 is a diagram showing an example of a DOM tree stored in a temporary storage area, as a result of the structured document 601 (first structured document 407) being analyzed by the element auto-extraction unit 304. As mentioned above, a DOM tree shows the data structure of elements contained in a structured document. The DOM tree of the structured document 601 has a <document> node 701 representing the entire document as a root node, and an <html> node 702 as a child node of the root node. The <html> node 702 further has a <body> node 704 and a <head> node 703 as child nodes.

Each element node holds data such as a pointer to a parent element node, a pointer to a sibling node, a pointer to a list of child nodes, attribute information, and text information. The display state and layout information of each element is defined in a CSS file, and the CSS files are stored in a temporary storage area as information on the element nodes of the DOM tree. For example, the font type, font size, character color and display position of the element are stored as such information on the element nodes. In the present embodiment, only elements are treated as nodes, and attribute and text information are treated as information on the element nodes. However, attribute and text information may also be treated as nodes of the DOM tree.

As shown in FIG. 7, the DOM tree contains an IFRAME element 708. Normally, the element nodes of the second structured document designated by the src attribute of the IFRAME element constitute a separate DOM tree 709, rather than being included in the DOM tree of the first structured document. In FIG. 7, the DOM tree of the first structured document and the DOM tree of the second structured document are shown as a single tree.

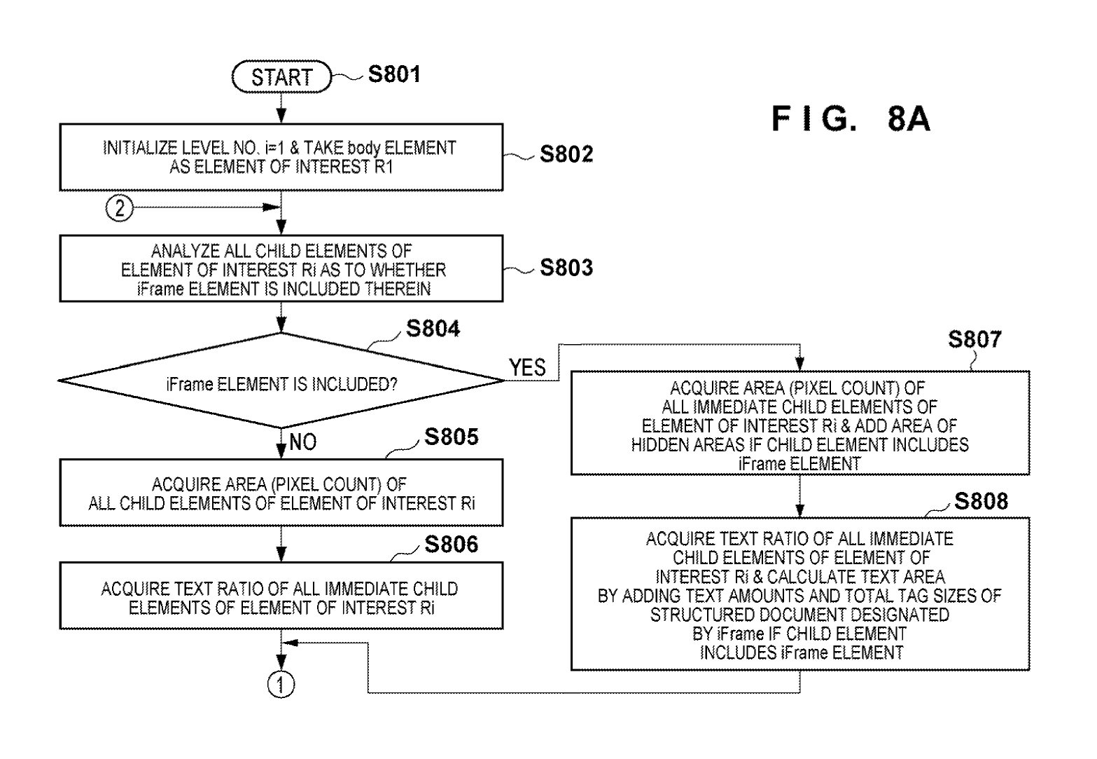

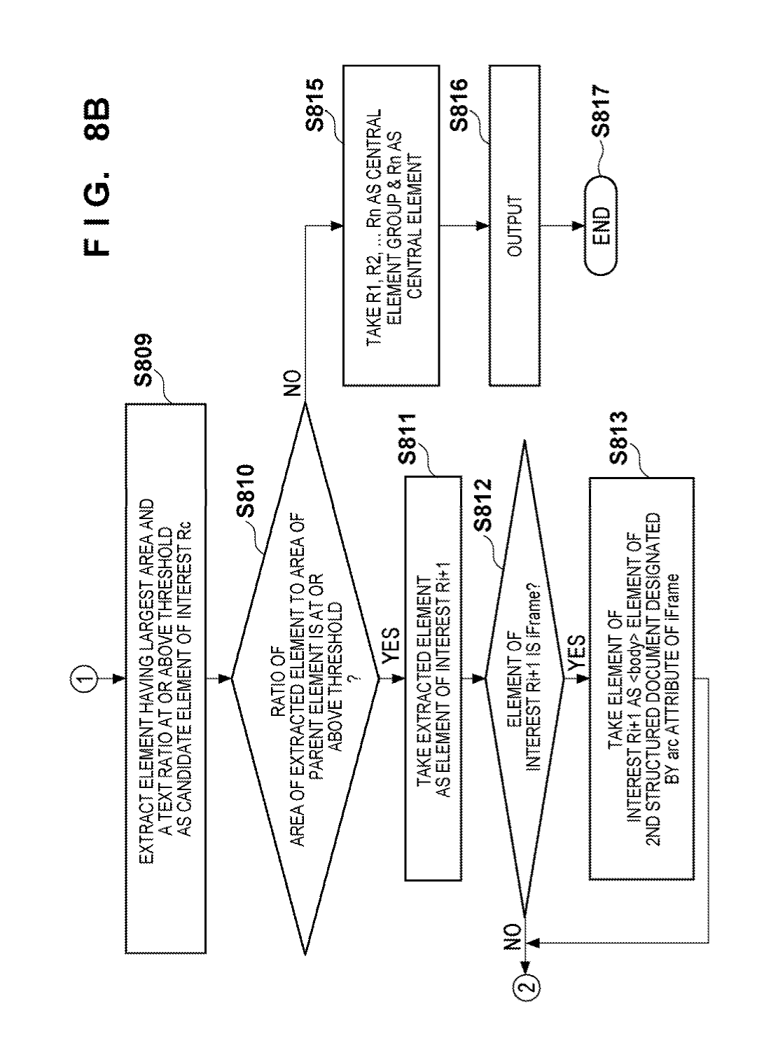

The element auto-extraction unit 304 treats the two DOM trees for the first structured document and the second structured document designated by an IFRAME element as a single DOM tree. In the present embodiment, the element auto-extraction unit 304, when analyzing the area, text amount and tag size of elements in the DOM tree of the first structured document, performs the analysis taking into account the area, text amount and tag size of the elements included in the DOM tree of the second structured document. Hereinafter, the processing procedure of the element auto-extraction unit 304 in the present embodiment will be described with reference to FIG. 8A and 8B.

FIG. 8A and 8B are flowcharts showing the processing procedure up to where the element auto-extraction unit 304 analyzes the structured document 303 and extracts a central element. The processing shown in FIG. 8A and 8B can be realized by the CPU 201 executing programs corresponding to the functional blocks of software shown in FIG. 3. When the Auto Extract button 406 of the browser 301 is pressed by the user and automatic extraction processing is instructed, the structured document print module 302 is launched and starts the processing of the element auto-extraction unit 304 (S801).

The element auto-extraction unit 304 reads out the structured document 303 via the browser 301, and constructs a DOM tree in a temporary storage area of the RAM 202. Note that in the case where the first structured document contains an IFRAME element at this time, the second structured document designated by the IFRAME element is also acquired from the browser together with the first structured document. The element auto-extraction unit 304 extracts the body element 704 within the DOM tree, and takes this body element 704 as an element of interest R1 (S802). Here, the element of interest R1 is an element of interest Ri (where i is natural number) whose initial value i is 1. The value “i” in the element of interest Ri is intended to represent the number of levels below the body element 704 of the DOM tree, with a lower level in the structured document being represented the higher the value of i is. That is, the body element 704 is R1 since that the body element itself is considered the first level.

Next, the partial display element detection unit 305 determines whether a partial display element is included in the group of child elements of the element of interest Ri (here R1, and hereinafter the same) (S803). Here, a partial display element is assumed to be an IFRAME element. In the case where, as a result of the processing in S803, it is determined that an IFRAME element is included (Yes in S804), the processing proceeds to S807, and in the case where it is determined that an IFRAME element is not included (No in S804), the processing proceeds to S805.

In S807, information indicating the width and height (in units of pixels) of each of the immediate child elements of the element of interest Ri is acquired. Note that the pixel count of an element can be acquired by analyzing the information contained in the HTML file. In the case where the pixel count is designated for elements such as images and tables, for example, the designated pixel count is acquired. Also, in the case where the size of an element is designated by a ratio to the size of the web page, the pixel count of an element can be acquired by calculating the number of pixels assigned to the element from the pixel count of the entire web page and the designated ratio. Further, in the case where a plurality of grades indicating the size of the elements is provided, as with the characters of a text element, and any of the grades are designated in the structured document, the size of an element can be acquired from the size when the element was placed in the web page and the pixel count of the entire web page.

Next, the area of each of the immediate child elements of the element of interest Ri is calculated from the number of pixels assigned to the elements shown in the information acquired in S807. In the present embodiment, if an IFRAME element is contained in any of the immediate child elements, the calculated area is taken as the area of the IFRAME element, with the areas of elements contained in the second structured document designated by that IFRAME element also included. In this case, the areas of elements that are assigned to hidden areas of the second structured document designated by the IFRAME element will also be taken into consideration. That is, the areas of all elements contained in the second structured document are added together, and the resultant area is taken as the area of the IFRAME element. Note that hidden areas of the second structured document refers to areas other than the area being displayed in the browser 301, among all areas that can be displayed by scrolling through the web page that is displayable based on the second structured document.

In S808, the element auto-extraction unit 304 acquires the text amount and XHTML tag size included in each of the immediate child elements of the element of interest Ri. In the present embodiment, in this case, if an IFRAME element is contained in any of the immediate child elements, the acquired text amount and XHTML tag size are taken as the text amount and XHTML tag size of the IFRAME element, with the text amounts and XHTML tag sizes of elements contained in the second structured document designated by that IFRAME element also included. That is, the text amounts and XHTML tag sizes of all elements contained in the second structured document are added together, and the resultant text amount and XHTML tag size are taken as the text amount and XHTML tag size of the IFRAME element.

The text ratio of each of the immediate child elements is calculated from the text amount and XHTML tag size acquired in S808. The text ratio is obtained by dividing the text amount by the XHTML tag size.

On the other hand, if it is determined that an IFRAME element is not included, in S805, the width and height (in units of pixels) of each of the immediate child elements of the element of interest Ri are acquired, similarly to S807. Next, the area of each of the immediate child elements of the element of interest Ri is acquired from the respective acquisition results. Further, in S806, the element auto-extraction unit 304 acquires the text amount and XHTML tag size included in each of the immediate child elements of the element of interest Ri. Next, the text ratio of each of the immediate child elements of the element of interest Ri is calculated.

In S809, an immediate child element of the element of interest Ri that has the largest area and a text ratio at or above a predetermined threshold is specified as a candidate element of interest Rc. Next, in S810, the area ratio of Rc to Ri is derived and compared with a predetermined threshold. If the ratio is at or above the predetermined threshold, the processing proceeds to S811, whereas if the ratio is below the predetermined threshold, the processing proceeds to S815.

An area ratio of Rc to Ri at or above the predetermined threshold denotes that Rc, which is central to the element of interest Ri, occupies a large area in Ri, which is the parent element. In this case, Ri could possibly contain an element that is more appropriate as the element to be output, and thus an element to serve as an output candidate is extracted by performing the above processing in S803 to S808 on the child elements contained in Ri. An example of the area ratio of Rc to Ri being at or above the predetermined threshold is the case where a large area is assigned to the second structured document embedded within the first structured document, and the text amount of elements contained in the second structured document is large.

In S811, the candidate element of interest Rc specified in S809 is assumed to be an element of interest R(i+1) (here R2, and hereinafter the same). According to the abovementioned example, this means that a second structured document embedded within the first structured document is taken as the element of interest R2.

In S812, it is determined whether the element of interest Ri+1 is an IFRAME element. Here, if determined to be an IFRAME element, the processing proceeds to S813, whereas if determined not to be an IFRAME element, the processing returns to the S803. In S813, the element of interest Ri+1 is taken as the <body> element of the second structured document designated by the src attribute of the IFRAME element, and the processing returns to S803.

In the processing shown in FIG. 8A and 8B, a second structured document 408 is specified, taking an element contained in the first structured document 407 displayed by the browser 301 that has the largest area and a text ratio at or above a threshold as a candidate element of interest Rc, for example (S809). Then, if that second structured document 408 is determined to be an IFRAME element (Yes in S812), the processing in S803 to S813 is further repeated inside the second structured document 408. If there is a third structured document further embedded inside the second structured document, an element of interest Rc is specified in S809, taking into account the elements contained in that third structured document.

Also, if in abovementioned S810 the area ratio of Rc to Ri is less than the predetermined threshold, the processing proceeds to S815. Then, Rc is taken as a central element Rn, and the elements that were set as R1 to Rn are taken as a group of central elements, where n is the level number of Rc at that time. In the case where the above third structured document is specified as the element of interest Rc in S809, the third structured document is specified and extracted as the central element in S815, if the area ratio of the third structured document to Ri is less than the predetermined threshold according to the condition of S810.

In other words, in the present embodiment, if another second structured document is further embedded in the first structured document, the second structured document is acquired in addition to the first structured document. A central element serving as an output candidate can then be extracted, with not only the elements contained in the first structured document but also the elements contained in a second structured document included. Accordingly, an element contained in a second structured document or the second structured document itself can be extracted as an element to be output if it is central to a web page.

According to the present embodiment, not only a central element, but elements specified as elements of interest from the uppermost level up to the central element being extracted are also extracted as a group of central elements. For example, in the case where a third structured document that is a child element of a second structured document is extracted as a central element, the first structured document, the second structured document and the third structured document are extracted as a group of central elements.

FIG. 5 will again be referred to in order to describe this group of central elements. Once the processing shown in FIG. 8A and 8B is performed, the central element is extracted and displayed in the area selection rectangle 502 as shown in FIG. 5. Here, in accordance with the above example, the central element displayed in the area selection rectangle 502 is assumed to be the third structured document. Here, when the user presses the “Wider” button 506, the element (second structured document) on the level above, out of the group of central elements, is displayed in a distinguishable manner in the area selection rectangle 502. When the user presses the “Narrower” button 507 in this state, the element (third structured document) on the level below, out of the group of central elements, is displayed in the area selection rectangle 502.

Once the central element is extracted in the S815, the processing proceeds to S816, where the element that was extracted in the S815 is output in a manner distinguishable from other elements contained in the structured document. In this case, the element may be output after adding an effect thereto so as to distinguish both the element and the other elements as shown in FIG. 5, for example, either only the central element or the group of central elements may be output. For example, in response to the central element being extracted in the S815, print layout by the print layout unit 307 may be performed on only the central element, and an image including only the central element may be printed on a printer. The output method is not limited thereto, and the element may, for example, be output to a display apparatus to display an image, or output to a printing apparatus to print an image. Alternatively, the element may be output to a recording medium internal or external to the PC 101, or transmitted to an external apparatus via the LAN interface 208 or the like. Once the element is output in S816, the processing is ended in S817.

As described above, in the present embodiment, a central element serving as an output candidate can be automatically extracted from elements within a web page, based on the area of the elements and the text amount of the elements, which indicates the number of characters shown by the element in the web page. As shown in FIG. 4, a variety of information such as menu titles is displayed in a web page, and there are many elements that the user will not want to output. Therefore, in the case where data is embedded in a frame within the web page when the user designates an element to be output, the user must check the area to be output by performing a separate scroll operation to the scroll operation on the web page. In the present embodiment, if data is embedded in a frame within a web page, data to be output that is included in the web page can be automatically selected, taking the embedded data into account. Thus, the user is able to designate appropriate data to be output with a simple operation. Further, according to the present embodiment, the element to be output can be switched within a group of central elements, enabling the user adjust the element to be output based on an automatically extracted element.

Note that in S810 of FIG. 8B the area ratio of Rc to Ri is derived, but a configuration may be adopted in which the area ratio of the body element to the element of interest Ri is derived. Also, in the above example, a candidate element of interest Rc is specified based on the area and text amount of the elements. However, in the present embodiment, a central element can be extracted in accordance with information indicating the contents of the elements, or a configuration may be adopted in which a candidate element of interest Rc is specified using the tag type, tag attributes, display style or the like of the elements. Also, in S809, one candidate element of interest Rc is specified, but a configuration may be adopted in which a plurality of candidate elements of interest Rc are specified. Also, in FIG. 8A and 8B, a central element is sought from the top down in the hierarchical structure of a DOM tree such as shown in FIG. 7, although a central element may be extracted by analyzing all elements in advance.

Also, in the above embodiment, it is judged whether to take a text element as a central element, based on the number of characters of the text included in the text element that are displayed on the display apparatus. However, the present invention is not limited thereto, and it may be judged whether to take a text element as a central element, based on the data amount assigned to the text included in the text element. For example, a text element that includes text having the largest number of bytes may be judged to be the central element, based on the number of bytes assigned to the characters included in the text. Generally, there are characters to which 2 bytes are assigned per character, and characters to which 1 byte is assigned per character. Therefore, if the judgment is performed in accordance with the number of bytes in a text as described above, a text that includes many characters having 2 bytes assigned thereto can be judged to be a text that is more central to the web page, even if the number of characters is the same.

Also, the above embodiment is not limited to the case where an element to be output is selected from elements contained in the first structured document or elements contained in the second structured document (elements within an IFRAME), and an element may be selected from each of the above two structured documents and output.

Further, as described in the above S807 to S809 of FIG. 8A and 8B, in the case where a second structured document (IFRAME element) is contained in the element of interest, the determination of the next element of interest is performed, with that IFRAME element as a child element contained in the element of interest. At this time, the determination may be performed after weighting the IFRAME element. For example, a prescribed value may be added to the area or text amount of the IFRAME element calculated in S807 and S808, or the calculated area or text amount may be multiplied by a prescribed multiplier. This enables the IFRAME element to be preferentially selected as an output target.

Also, in the above embodiment, an example was illustrated in which a link to another structured document is described as an IFRAME of a structured document, and the linked HTML file is inserted. However, the present invention is not limited thereto, and the user is also able select an element to be output in the case where an HTML file is inserted as a FRAME element, similarly to the case of the above IFRAME element.

Further, in the above embodiment, an example was illustrated in which a structured document is inserted into the frame within a web page. However, the present invention is not limited thereto, and is also applicable in the case where, for example, a link to a document file created by a word processing application or a spreadsheet file created by a spreadsheet application is designated within a structured document, and embedded within a web page. In this case, when extracting a document file or a spreadsheet file from a web page, the document file or spreadsheet file is extracted as an intermediate data file, similarly to the case where extraction is performed from a structured document embedded in a web page. Therefore, even if magnification processing is performed after extraction, the magnification process is performed on vector data, enabling degradation of the image following magnification to be suppressed in comparison to the case where magnification is performed on bitmap data.

Further, in the present embodiment, the area to be output within a web page was selected using plug-in software that works with the browser that display the web page. However, the present invention is not limited thereto, and a configuration may be adopted in which the functions described in the present embodiment are incorporated in the browser, and the browser itself selects an area to be output within a web page. Note that in the present embodiment, HTML and XHTML documents were described as examples of structured documents, although the present invention is also applicable to various types of structured documents such as XML documents.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-232782, filed Oct. 15, 2010, which is hereby incorporated by reference herein in its entirety.

What is claimed is:

1. An information processing apparatus comprising:
a first acquiring unit configured to acquire a first structured document, the first structured document containing a plurality of elements and having designated a second structured document to be inserted into a frame within a web page that is based on the first structured document;
a second acquiring unit configured to acquire the second structured document designated in the first structured document acquired by the first acquiring unit; and
a selecting unit configured to select an element to be output, from elements contained in the first structured document and the second structured document, based on the plurality of elements contained in the first structured document acquired by the first acquiring unit and an element contained in the second structured document acquired by the second acquiring unit.

2. The information processing apparatus according to claim 1, further comprising an outputting unit configured to output the element selected by the selecting unit, in a manner that distinguishes the selected element from other elements contained in the web page that is based on the first structured document acquired by the first acquiring unit.

3. The information processing apparatus according to claim 2, wherein the outputting unit outputs the element selected by the selecting unit and other elements contained in the web page that is based on the first structured document acquired by the first acquiring unit, in a manner that distinguishes the selected element and the other elements from each other.

4. The information processing apparatus according to claim 2, wherein the outputting unit outputs the element selected by the selecting unit, and does not output other elements contained in the web page that is based on the first structured document acquired by the first acquiring unit.

5. The information processing apparatus according to claim 1, further comprising a changing unit configured to, in response to an instruction by a user, change the element to be output from the element selected by the selecting unit to another element in the web page that is based on the first structured document acquired by the first acquiring unit.

6. The information processing apparatus according to claim 2, wherein the outputting unit prints an image corresponding to the element selected by the selecting unit on a printing apparatus.

7. The information processing apparatus according to claim 6, wherein the outputting unit acquires a print setting indicating a setting for performing printing on the printing apparatus, determines a layout of the element selected by the selecting unit based on the print setting, and prints on the printing apparatus an image on which the element is placed in accordance with the layout.

8. The information processing apparatus according to claim 1, wherein the selecting unit selects an element to be output, by determining whether to set an element contained in the first structured document as an output target, based on at least one of a text content indicated by the element and an area size corresponding to the element, in the web site that is based on the first structured document acquired by the first acquiring unit.

9. The information processing apparatus according to claim 1, wherein the selecting unit selects an element to be output, from at least one of an element contained in the first structured document acquired by the first acquiring unit and an element contained in the second structured document acquired by the second acquiring unit.

10. An information processing method comprising:
a first acquiring step of acquiring a first structured document, the first structured document containing a plurality of elements and having designated a second structured document to be inserted into a frame within a web page that is based on the first structured document;
a second acquiring step of acquiring the second structured document designated in the first structured document acquired in the first acquiring step; and
a selecting step of selecting an element to be output, from the elements contained in the first structured document and the second structured document, based on the plurality of elements contained in the first structured document acquired in the first acquiring step and an element contained in the second structured document acquired in the second acquiring step.

11. A computer-readable storage medium storing a program for causing a computer to execute:
acquiring a first structured document, the first structured document containing a plurality of elements and having designated a second structured document to be inserted into a frame within a web page that is based on the first structured document;
acquiring the second structured document designated in the acquired first structured document; and
selecting an element to be output, from the elements contained in the acquired first structured document and the acquired second structured document, based on the plurality of elements contained in the acquired first structured document and an element contained in the acquired second structured document.
